(19) United States
(12) Patent Application Publication
(10) Pub. No.: US 2025/0167836 A1
(43) Pub. Date: May 22, 2025

(54) RECONFIGURABLE INTELLIGENT SURFACE MODE SELECTION

(71) Applicant: Nokia Technologies Oy, Espoo (FI)

(72) Inventors: Muhammad TAYYAB, Oulu (FI); Marjo HEIKKILÄ, Nivala (FI)

(21) Appl. No.: 18/945,671

(22) Filed: Nov. 13, 2024

Related U.S. Application Data
(60) Provisional application No. 63/600,078, filed on Nov. 17, 2023.

(51) Int. Cl. H04B 7/04

(52) U.S. Cl. CPC H04B 7/04013

(57) ABSTRACT

In accordance with example embodiments of the invention there is at least a method and apparatus to perform communicating with a network node or a network device of a communication network to exchange capabilities including a plurality of passive elements which are controlled by an active device for use of at least one particular mode for signalling in the communication network, wherein the active device configures the apparatus to perform: receiving from the network node or the network device a mode selection request for a particular mode; based on the mode selection request and availability of the particular mode, sending towards the network node or the network device a mode selection response, wherein the mode selection response includes an acknowledgement for activation of the particular mode; and operating in the particular mode to enable communication between a network device and the network node via the reconfigurable intelligent surface.

### RELATED APPLICATION

This application claims priority to U.S. provisional Application No. 63/600,078 filed Nov. 17, 2023, which is incorporated herein by reference in its entirety.

### TECHNICAL FIELD

The teachings in accordance with the exemplary embodiments of this invention relate generally to improved aspects of an apparatus and/or a Reconfigurable Intelligent Surface (RIS) and, more specifically, relate to improved aspects of the apparatus and/or the Reconfigurable Intelligent Surface (RIS) mode selection.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AIoT Ambient IoT
FD Full duplex
FDD Frequency division duplex
HD Half duplex
OAM Operation and maintenance
RIS Reconfigurable Intelligent Surface
TDD Time division duplex
UE User Equipment

A wireless propagation environment is random and uncontrollable. Recently, apparatus such as including reconfigurable intelligent surfaces (RISs) have been proposed as a means of having some control over them with the help of software-controlled reflections. An RIS consists of a planar array of passive reflecting elements that can reflect the incoming rays with adjustable phase shifts. The passive nature of the reflecting elements results in low hardware costs, low energy consumption, and the ability to naturally operate in different modes such as full-duplex (FD) mode. An RIS will be a low-profile auxiliary device that can be easily integrated into an existing communication network transparently, providing great flexibility and compatibility in terms of deployment.

Example embodiments of this invention proposes improved procedure operations for such apparatus and/or reconfigurable intelligent surfaces.

### SUMMARY

This section contains examples of possible implementations and is not meant to be limiting.

In another example aspect of the invention, there is an apparatus, such as a base station type or network device type apparatus, comprising: at least one processor; and at least one non-transitory memory storing instructions, that when executed by the at least one processor, cause the apparatus at least to: communicate with a network node of a communication network to exchange capabilities of the apparatus comprising a plurality of passive elements which are controlled by an active device for use of at least one particular mode for signalling in the communication network, wherein the active device configures the apparatus to: receive from the network node a mode selection request for a particular mode; based on the mode selection request and availability of the particular mode, send towards the network node a mode selection response, wherein the mode selection response comprises an acknowledgement for activation of the particular mode; and operating in the particular mode to enable communication between a user equipment and the network node.

In still another example aspect of the invention, there is a method, comprising: communicating with a network node of a communication network to exchange capabilities of the apparatus comprising a plurality of passive elements which are controlled by an active device for use of at least one particular mode for signalling in the communication network, wherein the active device configures the apparatus to: receive from the network node a mode selection request for a particular mode; based on the mode selection request and availability of the particular mode, send towards the network node a mode selection response, wherein the mode selection response comprising an acknowledgement for activation of the particular mode; and operate in the particular mode to enable communication between a user equipment and the network node.

A further example embodiment is an apparatus and a method comprising the apparatus and the method of the previous paragraphs, wherein the mode selection response indicates whether the apparatus is available for the particular mode, wherein the apparatus comprises at least one of a reconfigurable intelligent surface (RIS), intelligence reflecting surfaces (IRS), large intelligent surfaces, or array of reconfigurable reflecting antenna elements, wherein the apparatus includes a reconfigurable intelligent surface that comprises a reconfigurable intelligent surface control unit and a reconfigurable intelligent surface forwarding unit, wherein there is checking availability with the apparatus for the particular mode of operation; and allocating passive array elements and reconfigure using the parameters for a forwarding operation, wherein identifying the at least one reconfigurable intelligent surface of the apparatus is available based on a mode selection response, wherein the at least one particular mode comprises a reflection mode, transparent mode, a half-duplex or full-duplex mode, a mirror mode, an off mode, and a cascade mode, wherein in the reflection mode the apparatus reflects the signalling towards a desired direction based on the configuration, wherein beams of the reflection mode for the signalling are symmetrical in an uplink and a downlink direction, and wherein a ratio between an incident angle and a reflected angle are equal, wherein the reflection mode is one option for a forwarding operation based on the particular mode being available, wherein in the transparent mode the apparatus applies a transparent mode operation to refract a beam for transmitting the signalling towards a specified direction, wherein the refraction mode is one option for forwarding mode for the apparatus based on the particular mode being available, wherein in the half duplex mode, the signalling is transmitted with time Division duplexing or frequency-division duplexing, wherein the half duplex mode is a default mode, wherein the apparatus enables spatial multiplexing for a full duplex mode, wherein based on spatial multiplexing being used for forwarding the signalling, the full-duplex mode is enabled with simultaneous uplink transmission and downlink transmission, and wherein elements of the apparatus are functionally divided into a part that reflects the uplink transmission and another part that reflects the downlink transmission, wherein in full-duplex mode, the signalling is transmitted in uplink and downlink directions on a same frequency range at a same time, wherein in the mirror mode, a beam is scattered back to the return direction of an incident beam, wherein the mirror mode is used for channel state evaluation, and estimating the location of a mobile at least one reconfigurable intelligent surface for communicating, wherein in the off mode, there is no forwarding operation, wherein the off mode is implemented by at least one of using the absorptive mode, uniform scattering mode, and surface wave mode, or using scattering, and wherein the apparatus scatters a beam into multiple beams over a wide angle, wherein in the cascade mode at least one reconfigurable intelligent surface of the apparatus is linked to help form a connection overcoming blockages, wherein the parameters comprise an angle of reflection, frequency, and a phase adjustment, and/or wherein enabling forwarding using the particular mode is based on implementing the configuration using parameters and applying an on state to the apparatus.

A non-transitory computer-readable medium storing program code, the program code executed by at least one processor to perform at least the method as described in the paragraphs above.

In yet another example aspect of the invention, there is an apparatus comprising: means for communicating with a network node of a communication network a capability of the apparatus for use of at least one particular mode for signalling in the communication network; means, based on a determined need for a particular mode of the at least one particular mode, for receiving from the network node a mode selection request for the particular mode; means, based on the mode selection request, for sending towards the network node a mode selection response comprising an acknowledgement for activation of the particular mode; and means for performing signalling using the particular mode via the apparatus in the communication network to enable communication between a user equipment and the network node

In accordance with the example embodiments as described in the paragraph above, at least the means for communicating, receiving, sending, and performing comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: communicate with a network device of a communication network to exchange capabilities comprising a plurality of passive elements which are controlled by an active device for use of at least one particular mode for signalling in the communication network; based on a determined need for a particular mode of the at least one particular mode, send towards the network device a request for the particular mode; receive a mode selection response, wherein the mode selection response comprises an acknowledgement for activation of the particular mode; and communicate with a user equipment via the network device using the particular mode.

In still another example aspect of the invention, there is a method, comprising: communicating with a network device of a communication network to exchange capabilities of the network device comprising a plurality of passive elements which are controlled by an active device for use of at least one particular mode for signalling in the communication network; based on a determined need for a particular mode of the at least one particular mode, sending towards the network device a request for the particular mode; receive a mode selection response, wherein the mode selection response comprises an acknowledgement for activation of the particular mode; and communicating with a user equipment via the network device using the particular mode.

A further example embodiment is an apparatus and a method comprising the apparatus and/or network device and the method of the previous paragraphs, wherein the mode selection response indicates whether the apparatus is available for the particular mode, wherein the apparatus comprises at least one of a reconfigurable intelligent surface (RIS), intelligence reflecting surfaces (IRS), large intelligent surfaces, or array of reconfigurable reflecting antenna elements, wherein a reconfigurable intelligent surface of the apparatus comprises a reconfigurable intelligent surface control unit and a reconfigurable intelligent surface forwarding unit, wherein the mode selection response is based on a check of availability with the apparatus for the particular mode of operation; and allocation of passive array elements and reconfigure using the parameters for a forwarding operation, wherein identifying at least one reconfigurable intelligent surface of the apparatus is available is based on a mode selection response, wherein the at least one particular mode comprises a reflection mode, transparent mode, a half-duplex or full-duplex mode, a mirror mode, an off mode, and a cascade mode, wherein in the reflection mode the apparatus reflects the signalling towards a desired direction based on the configuration, wherein beams of the reflection mode for the signalling are symmetrical in an uplink and a downlink direction, and wherein a ratio between an incident angle and a reflected angle are equal, wherein the reflection mode is one option for a forwarding operation based on the particular mode being available, wherein in the transparent mode the apparatus applies a transparent mode operation to refract a beam for transmitting the signalling towards a specified direction, wherein the refraction mode is a normal forwarding mode based on the particular mode being available, wherein in the half duplex mode, the signalling is transmitted with time Division duplexing or frequency-division duplexing, wherein the half duplex mode is a default mode, wherein the apparatus enables spatial multiplexing for a full duplex mode, wherein based on spatial multiplexing being used for forwarding the signalling, the full-duplex mode is enabled with simultaneous uplink transmission and downlink transmission, and wherein elements of the apparatus are functionally divided into a part that reflects the uplink transmission and another part that reflects the downlink transmission, wherein in full-duplex mode, the signalling is transmitted in uplink and downlink directions on a same frequency range at a same time, wherein in the mirror mode, a beam is scattered back to the return direction of an incident beam, wherein the mirror mode is used for channel state evaluation, and estimating the location of a mobile at least one reconfigurable intelligent surface for communicating, wherein in the off mode, there is no forwarding operation, wherein the off mode is implemented by at least one of using the absorptive mode, uniform scattering mode, and surface wave mode, or using scattering, and wherein a beam is scattered into multiple beams over a wide angle, wherein in the cascade mode at least one reconfigurable intelligent surface is linked to help form a connection overcoming blockages, wherein the parameters comprise an angle of reflection, frequency, and a phase adjustment, and/or wherein enabling forwarding using the reconfigurable intelligent surface operating in the particular mode is based on implementing the configuration using parameters and applying an on state to the reconfigurable intelligent surface

A non-transitory computer-readable medium storing program code, the program code executed by at least one processor to perform at least the method as described in the paragraphs above.

In yet another example aspect of the invention, there is an apparatus comprising: means for communicating with a network device of a communication network to exchange capabilities comprising a plurality of passive elements which are controlled by an active device for use of at least one particular mode for signalling in the communication network; means, based on a determined need for a particular mode of the at least one particular mode, for sending towards the network device a request for the particular mode; means for receiving a mode selection response, wherein the mode selection response comprises an acknowledgement for activation of the particular mode; and means for communicating with a user equipment via the network device using the particular mode.

In accordance with the example embodiments as described in the paragraph above, at least the means for communicating, sending, receiving, and performing comprises a network interface, and computer program code stored on a computer-readable medium and executed by at least one processor.

A communication system comprising the network side apparatus and the network device type apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a hardware architecture of a reconfigurable intelligent surface (RIS);

FIG. 2 shows a reconfigurable intelligent surface (RIS) architecture from a 3GPP point of view;

FIG. 3 shows a proposed a reconfigurable intelligent surface architecture in accordance with example embodiments of the invention, where there are active elements for channel sensing in addition to passive elements;

FIG. 4 shows RIS-assisted ambient energy harvesting;

FIG. 5 shows a high level block diagram of various devices used in carrying out various aspects of the invention;

FIG. 6 shows a general network-initiated mode selection procedure;

FIG. 7 shows signal reflection in accordance with example embodiments of the invention;

FIG. 8 shows signal refraction in transparent mode in accordance with example embodiments of the invention;

FIG. 9 shows a reflection mode selection procedure in accordance with example embodiments of the invention;

FIG. 10 shows evaluation of the requirement and need for the mode in accordance with example embodiments of the invention;

FIG. 11 shows applying a mode selection request: implementing configuration and changing RIS to ON-state in accordance with example embodiments of the invention;

FIG. 12 shows a signal scattering back to the return direction in accordance with example embodiments of the invention;

FIG. 13 shows a network-initiated mirror mode selection in accordance with example embodiments of the invention;

FIG. 14 shows absorption of the signal in accordance with example embodiments of the invention;

FIG. 15 shows a network-initiated OFF mode selection in accordance with example embodiments of the invention;

FIG. 16 shows evaluation of a need for RIS OFF state in accordance with example embodiments of the invention;

FIG. 17 shows a linked RISs create a virtual LOS and connection between UE and gNB in accordance with example embodiments of the invention;

FIG. 18 shows a network-initiated Cascade mode selection in accordance with example embodiments of the invention; and

FIG. 19A and FIG. 19B each show a method in accordance with example embodiments of the invention which may be performed by an apparatus.

### DETAILED DESCRIPTION

In example embodiments of this invention there is proposed at least a method and apparatus for new operations related to improved aspects of Reconfigurable Intelligent Surface (RIS) mode selection.

### Reconfigurable Intelligent Surface (RIS)

As similarly stated above, the wireless propagation environment is random and uncontrollable. Recently, reconfigurable intelligent surfaces (RISs) have been proposed as a means of having some control over them with the help of software-controlled reflections.

An RIS consists of a planar array of passive reflecting elements that can reflect the incoming rays with adjustable phase shifts. The passive nature of the reflecting elements results in low hardware costs, low energy consumption, and the ability to naturally operate in different modes such as full-duplex (FD) mode. An RIS will be a low-profile auxiliary device that can be easily integrated into an existing communication network transparently, providing great flexibility and compatibility in terms of deployment.

Reconfigurable intelligent surfaces (RISs) are surfaces that can be used with network devices such as user equipment (UEs, which are wireless, typically mobile devices) and network entities or network nodes, such as base stations, e.g., for cellular networks. RISs are also known as “reconfigurable reflecting surfaces”, “intelligent reflecting surface (IRS)”, “large intelligent surfaces”, “array of reconfigurable reflecting antenna elements”, and the term “RIS” as used herein is meant to cover all of these and other similar devices. Current implementations of RIS are based on liquid crystal meta-structures, reconfigurable reflect arrays, mechanical structures, and programmable metamaterials or a combination of these.

Reconfigurable Intelligent Surface (RIS) with Active Elements

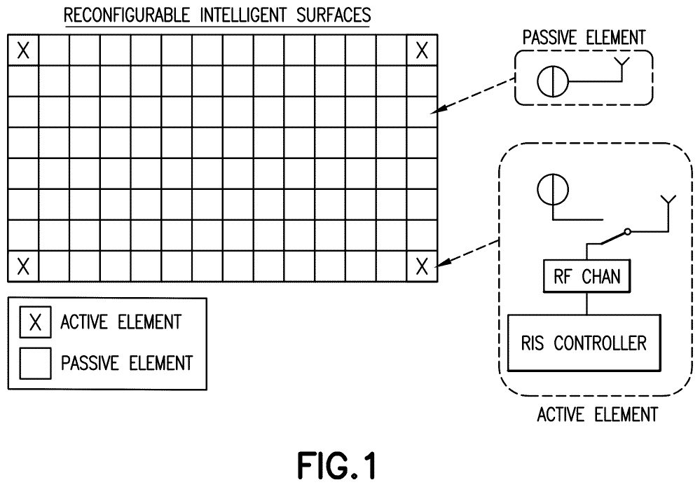

In addition to passive elements, an RIS can have reconfigurable active elements, where it can be connected to an RF chain by a switch as shown in FIG. 1.

These active elements can be used for different functions such as:
Communicating control messages between RIS and BS;
Channel sensing by measuring reference signals.

Passive elements will reflect the incoming signals, and phases of the passive elements can be configured to steer the incoming signals in the desired direction.

FIG. 1 shows a hardware architecture of a reconfigurable intelligent surface (RIS). As shown in FIG. 1 there are passive elements and active elements. As shown in FIG. 1 the active elements are linked to a RF chain and RIS controller.

### Operating Frequency of RIS

Ambient energy is composed of different signals at various frequencies. However, it is difficult to implement an RIS that supports phase adjustment for incoming signals at different frequency bands simultaneously. There is a focus on frequency reconfigurable antennas in the current state-of-the-art research, where an antenna that can reconfigure its operating frequency from 4.86 to 5.89 GHz is presented. A similar approach can be used to facilitate RIS to support phase adjustment at different frequencies, while a specific frequency can be set for a group of elements at a given time.

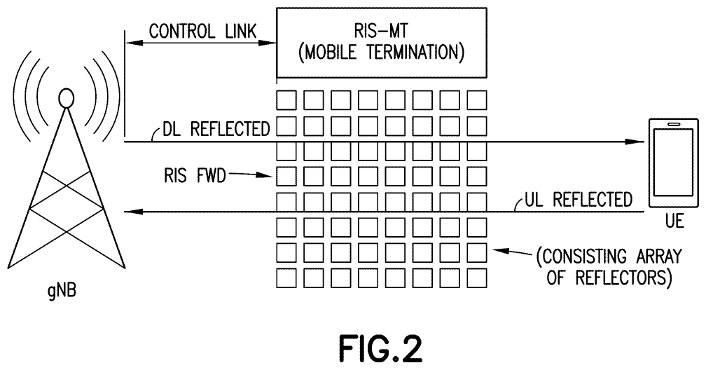

FIG. 2 shows a reconfigurable intelligent surface (RIS) architecture from a 3GPP point of view. As shown in FIG. 2 there is a gNB and a UE performing RS-MT (Mobile Termination). As shown in FIG. 2 the gNB is sending to the UE a DL reflected. The UE of FIG. 2 is responding via an RS-Fwd with a UL reflected (consisting of an array of reflectors).

The RIS-MT (Control Unit) is defined as a component to maintain the Control link (C-link) between gNB and RIS to enable the information exchanges (e.g., side control information). The C-link is based on the NR Uu interface and on a different frequency band as Forwarding-link. The forwarding link is decoupled from C-link. RIS reflects the signal without decoding. The angle of reflection can be controlled dynamically.

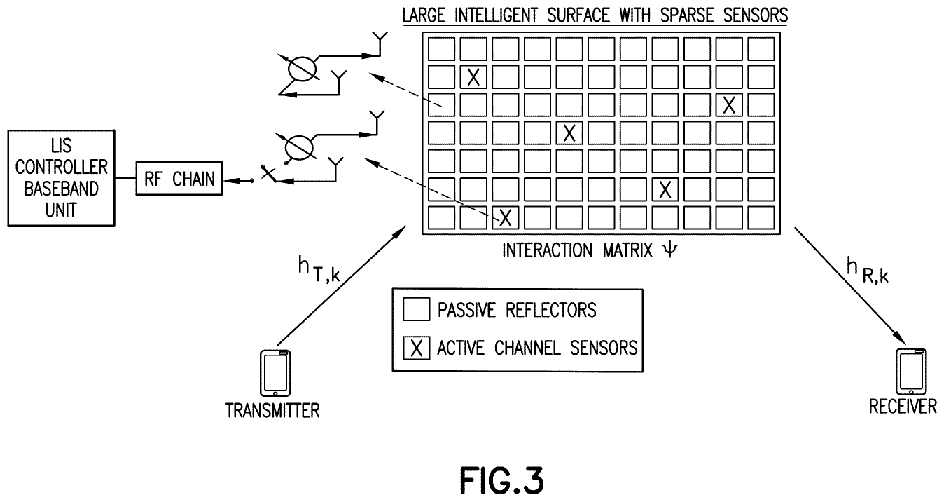

FIG. 3 shows a proposed a reconfigurable intelligent surface architecture in accordance with example embodiments of the invention, where there are active elements for channel sensing in addition to passive elements.

A novel Reconfigurable Intelligent Surface (RIS) architecture is proposed (as illustrated in FIG. 3), where all the elements are passive except a few randomly distributed active channel sensors. These active sensors are connected to the baseband of the controller. A compressive sensing-based solution is used to recover full channels between RIS, and transmitter/receiver, which is used to optimize the phases of passive elements.

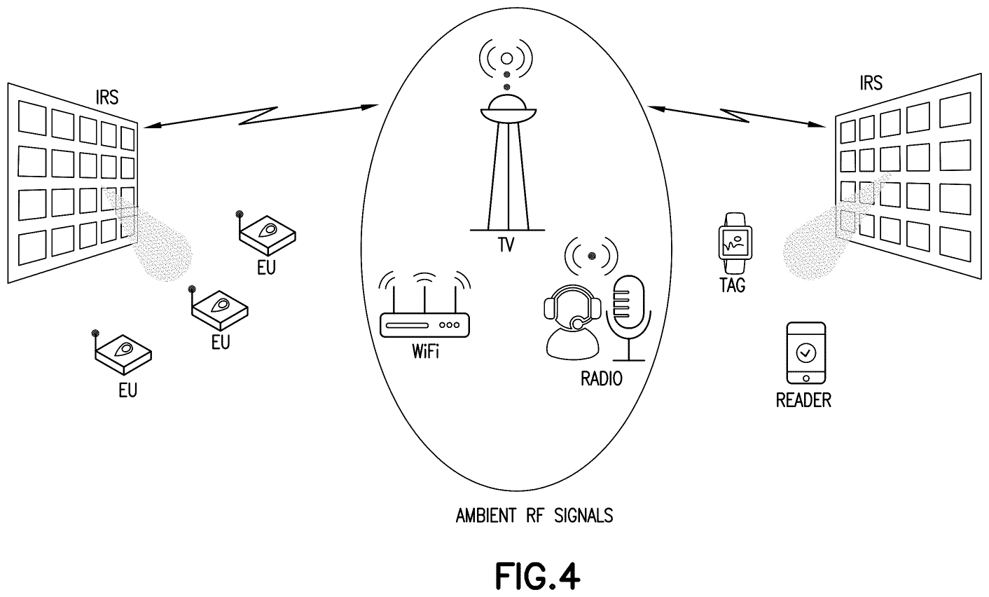

Numerous ambient RF signals exist, such as TV, radio, cellular, and Wi-Fi signals, which could be potential energy sources for energy. However, It is difficult for energy users (EUs) to efficiently harvest energy from these abundantly available signals due to their randomness in nature and due to these energy sources being available at different frequencies. In RIS is mentioned as a highly promising solution to resolve this problem since the ambient signals can be focused on EUs by exploiting the passive beamforming capability, which is illustrated in FIG. 4.

FIG. 4 shows RIS-assisted ambient energy harvesting. As shown in FIG. 4 there is different IRS with a TV (including Wifi and radio) in between. One of the IRS connecting to UEs and the other IRS connected to a Tag and a reader.

To the best of our knowledge, the aspect of RIS mode selection (which could be applied in 3GPP) is overlooked in the literature. Example embodiments of the invention work to address at least this shortfall of the standards at the time of this application.

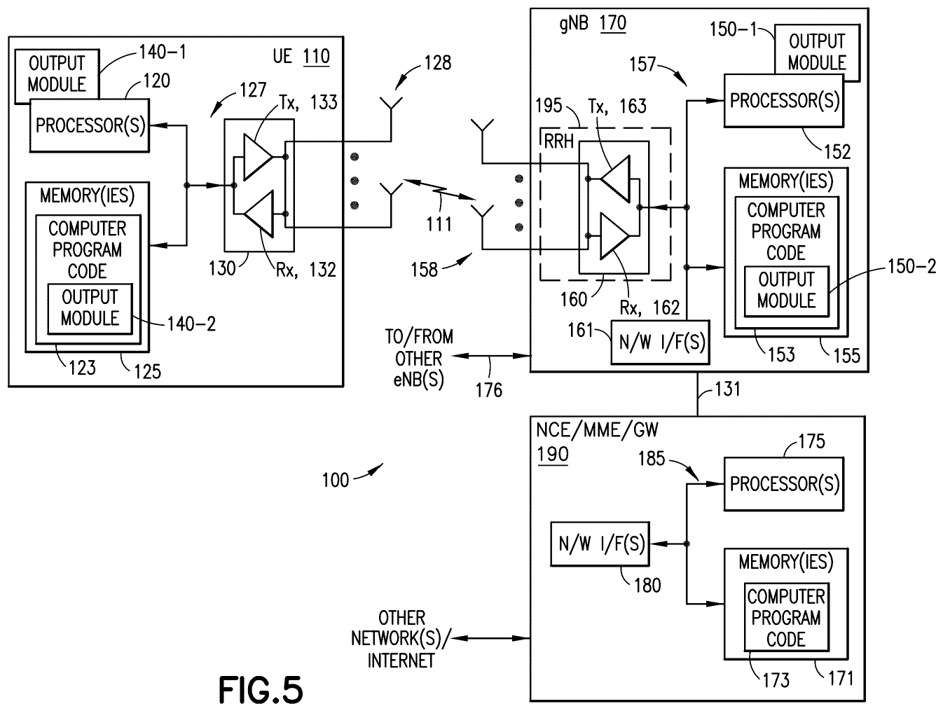

Before describing the example embodiments as disclosed herein in detail, reference is made to FIG. 5 for illustrating a simplified block diagram of various electronic devices that are suitable for use in practicing the example embodiments of this invention.

FIG. 5 is a block diagram of one possible and non-limiting system in which the example embodiments may be practiced.

Turning to FIG. 5, this figure shows a block diagram of one possible and non-limiting example in which the examples may be practiced. A user equipment (UE) 110, and a radio access LTE, 5G, or 6G network base station i.e., gNB 170, and NCE/MME/GW 190 are illustrated. In the example of FIG. 5, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a output module 140, comprising one of or both parts 140-1 and/or 140-2, which may be implemented in a number of ways. The output module 140 may be implemented in hardware as output module 140-1, such as being implemented as part of the one or more processors 120. The output module 140-1 may be implemented also as an integrated circuit or through other hardware such as a programmable gate array. In another example, the output module 140 may be implemented as output module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB 170 in this example is a base station that provides access by wireless devices such as the UE 110 to the wireless network 100. The gNB 170 may be, for example, a base station for 5G, also called New Radio (NR). In 5G, the gNB 170 may be a NG-RAN node, which is defined as either a gNB or an ng-eNB. A gNB is a node providing NR user plane and control plane protocol terminations towards the UE, and connected via the NG interface to a 5GC (such as, for example, the NCE/MME/GW 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the gNB 170 and centralized elements of the gNB 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The gNB 170 may also be an eNB (evolved NodeB) base station, for LTE (long term evolution), or any other suitable base station or node.

The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The gNB 170 includes a output module 150, comprising one of or both parts 150-1 and/or 150-2, which may be implemented in a number of ways. The output module 150 may be implemented in hardware as output module 150-1, such as being implemented as part of the one or more processors 152. The output module 150-1 may be implemented also as an integrated circuit or through other hardware such as a programmable gate array. In another example, the output module 150 may be implemented as output module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. Note that the functionality of the output module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 receiver for gNB implementation for 5G, with the other elements of the gNB 170 possibly being physically in a different location from the RRH/DU, and the one or more buses 157 could be implemented in part as, for example, fiber optic cable or other suitable network connection to connect the other elements (e.g., a central unit (CU), gNB-CU) of the gNB 170 to the RRH/DU 195. Reference 198 also indicates those suitable network link(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality. Further, this NCE/MME/GW 190 can for example perform Access & Mobility Management Function (AMF), Location Management Function (LMF), Mobility Management Entity (MME), Network Control Element (NCE), Policy Control Function (PCF), Serving Gateway (SGW), Session Management Function (SMF), and Unified Data Management (UDM). The NCE/MME/GW 190 provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the NCE/MME/GW 190, and note that both 5G and LTE functions might be supported. The gNB 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, NCE/MME/GW 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

As similarly stated above, To the best of our knowledge, the aspect of RIS mode selection (which could be applied in 3GPP) is overlooked in the literature. Example embodiments of the invention work to address at least this shortfall of the standards at the time of this application.

RIS are low-cost elements and can be used in various modes. However, RIS technology has not been designed for providing such solutions which could apply to 3GPP and there is a need to solve this technical problem. One problem solved in example embodiments of the invention is how to define various mode and mode selections for RIS, where subproblems are:
1. How to define various RIS modes and triggering conditions for each mode?;
2. How to perform network-controlled Mode selection?

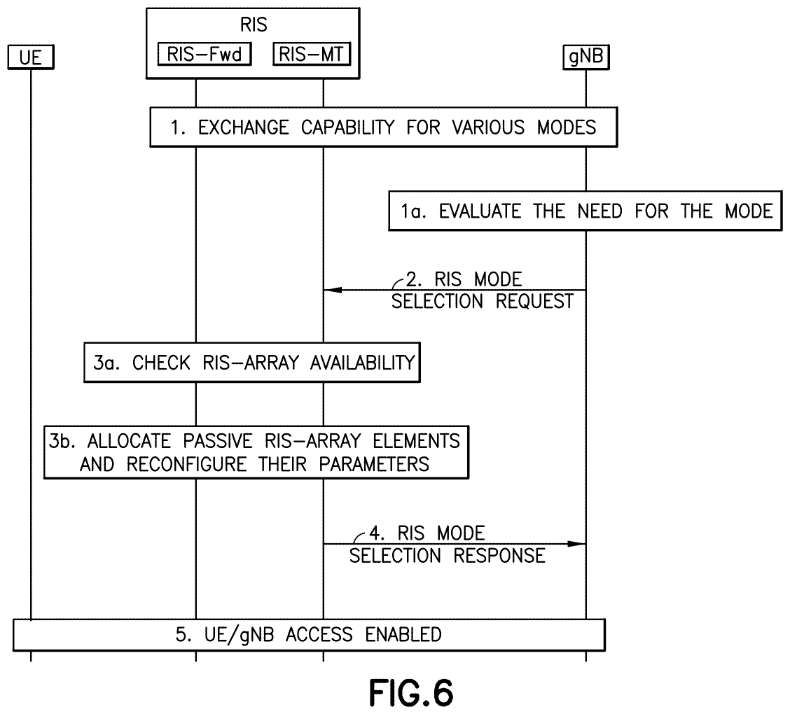

In example embodiments of this invention, there is defined various RIS modes and the triggering conditions for the selection of a particular mode. The RIS modes include HD/FD modes, Reflection mode, Transparent mode, Mirror mode, OFF mode, and Cascade mode. Example embodiments of the invention propose a procedure for gNB-initiated RIS mode selection and related required signaling in accordance with example embodiments of the invention as shown in FIG. 6 and described as follows:
1. In accordance with example embodiments of the invention, as shown in step 1 of FIG. 6 the RIS communicates its capability with the gNB for various modes with the network. The C-link connection establishment between gNB and RIS (via RIS-MT) is required before initializing the RIS mode selection:
   a. In step 1a of FIG. 6 there is, based on this capability information, the gNB evaluating the need for a particular mode e.g. HD/FD modes, Reflection mode, Transparent mode, Mirror mode, OFF mode, and Cascade mode:
      i. The gNB evaluation could be based on UE request via RIS to gNB for a specific mode or gNB need for a specific mode;
2. As shown in step 2 of FIG. 6 there is in accordance with example embodiments of the invention, based on a specific need, the gNB sending a mode selection request to the RIS-MT:
   a. In one example case, the gNB provides the related configuration parameters for RIS-MT to apply the mode. The parameters include the angle of reflection, frequency, phase adjustment, etc.;
3. In accordance with example embodiments of the invention, as shown in step 3a of FIG. 6 the RIS-MT checks the availability of RIS-Fwd for a particular mode of operation. As shown in step 3b of FIG. 6 the RIS-MT then allocates the passive RIS array elements and reconfigures their parameters (i.e. based on step 3a) for forwarding operation;
4. In accordance with example embodiments of the invention, the RIS-MT sends a mode selection response to the gNB (which could be “yes” in case the RIS is available for this mode, or it could be “no” if RIS is busy with some other tasks, i.e. due to connection with other gNBs e.g. high priority for another mode);
5. Finally, in accordance with example embodiments of the invention, as shown in step 4 and 5 of FIG. 6 the RIS starts operating in the requested mode. The network enables the UE or gNB access via RIS.

Herein is provided required signalling and triggering conditions over the radio interface to enable all the above modes selection as needed (or triggered).

Herein there is provided the signaling chart for each mode and possible triggering conditions for each mode. The RIS modes include HD/FD modes, Reflection mode, Transparent mode, Mirror mode, OFF mode, and/or a Cascade mode.

### Reflection Mode, Transparent Mode, and HD/FD Mode

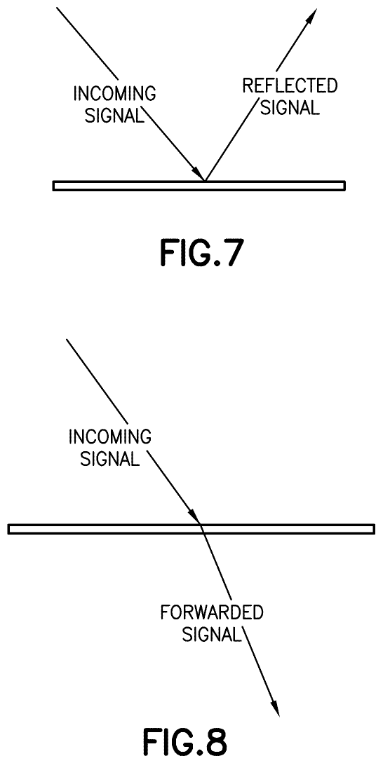

FIG. 7 shows signal reflection in accordance with example embodiments of the invention. As shown in FIG. 7 there is an incoming signal and a reflected signal.

Definition: On reflection mode (if supported by RIS type), the RIS reflects the impinging signal towards the desired direction based on the configuration from gNB/OAM as shown in FIG. 7. The reflection mode is the “normal” forwarding mode for RIS. The Beams are symmetrical in uplink and downlink direction e.g. the ratio between the incident angle and reflected angle is equal.

Assumptions: gNB knows RISs are available, and the coverage holes are identified e.g., by network planning.

Use Cases: Outdoor, coverage area enhancement scenarios, Indoor, UE-initiated reflection mode e.g. persistent beam for UE.

### Transparent Mode

FIG. 8 shows signal refraction in transparent mode in accordance with example embodiments of the invention. As shown in FIG. 8 there is an incoming signal and a forwarded signal.

Definition: On transparent mode (if supported by RIS type), RIS refracts an impinging beam towards a specified direction as shown in FIG. 8. Refraction mode is the “normal” forwarding mode for RIS (if the mode is supported).

Assumptions: Coverage area holes can be identified in network planning and walk testing phases.

### Use Cases: Outdoor to Indoor Use Cases.

### HD/FD Mode

Definition: In half-duplex mode (HD), data can be transmitted with Time Division duplexing (TDD) or Frequency-division duplexing (FDD). In full-duplex mode (FD), data is transmitted in UL and DL directions on the same frequency range at the same time. HD is the default mode. The benefit of FD is that the FD BSs and RIS can be deployed in combination to improve the overall system performance.

The drawback is the new type of interference.

RIS enables spatial multiplexing for FD mode. When spatial multiplexing is in the use, the FD mode is enabled with simultaneous UL and DL transmission, by RIS elements which can be functionally divided into two parts. One part of the RIS elements reflects the UL transmission and another part of the RIS elements reflects the DL transmission.

Use Cases of HD: In (TDD) systems, uplink-downlink configuration determines how subframes in a radio frame are divided between the downlink and the uplink. To avoid interferences networks are synchronized where all networks are in uplink or downlink mode at the same time.

Use Cases of FD: Enhanced user performance, UL performance booster for dense urban areas with high frequencies, enables higher throughput and low latency, flexible scheduling, good for high-priority FR2 users and critical business-to-business applications.

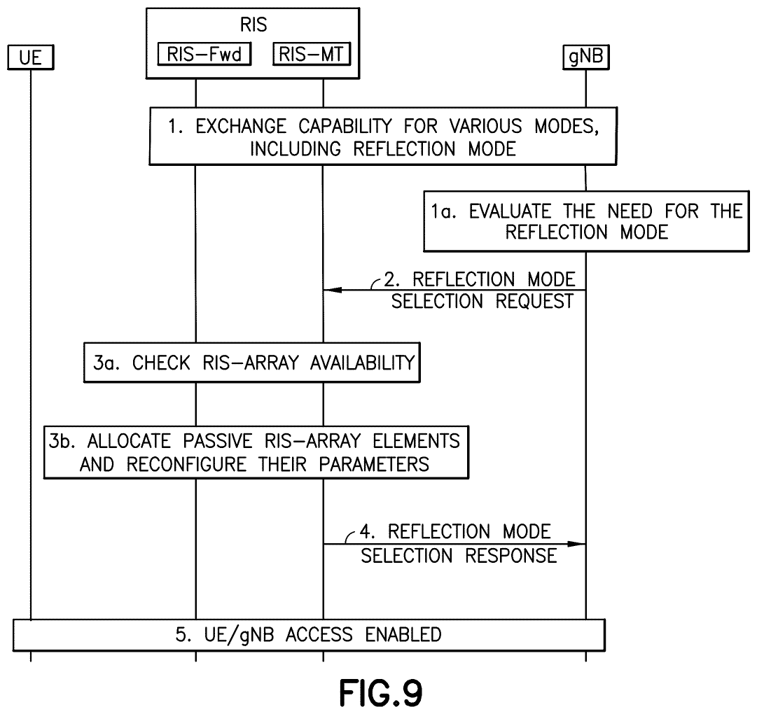

FIG. 9 shows a signaling Chart that applies to Reflection, Transparent, and HD/FD modes in accordance with example embodiments of the invention.

FIG. 9 shows a reflection mode selection procedure in accordance with example embodiments of the invention.

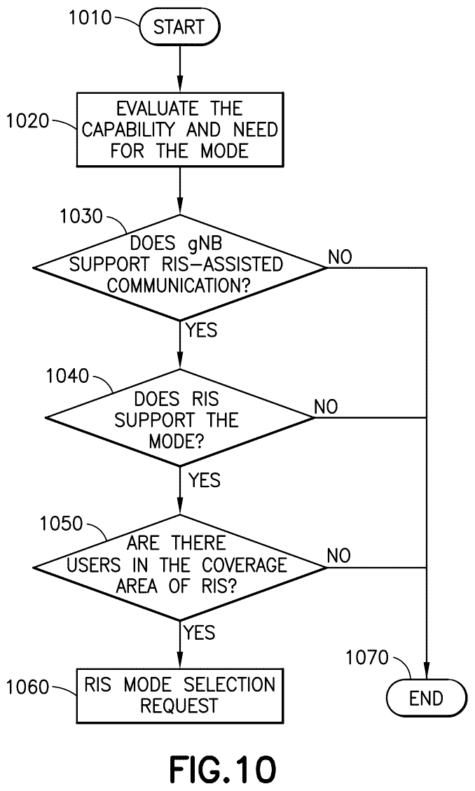

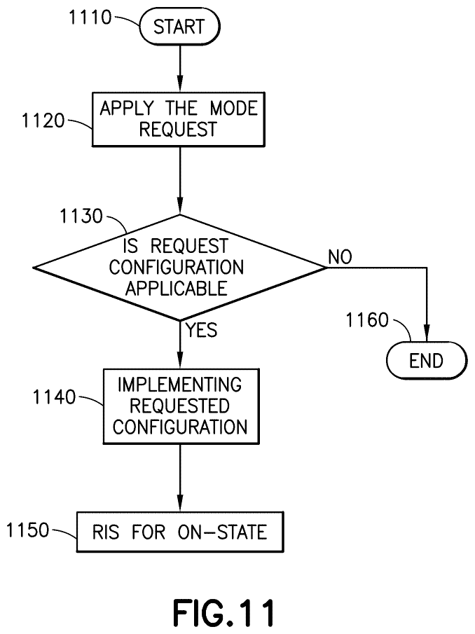

One proposed signaling chart for Reflection mode in accordance with example embodiments of the invention is shown in FIG. 9 and described as follows, it is to be noted that the same diagram applies to transparent and HD/FD modes:
1. In accordance with example embodiments of the invention, as shown in step 1 of FIG. 9 the RIS communicates its capability for various modes with the network. The C-link connection establishment between gNB and RIS (via RIS-MT) is required before initializing the RIS mode selection:
   a. In step 1a of FIG. 9 there is, based on this capability information, the gNB evaluates the need for Reflection or HD/FD, or transparent mode as shown in FIG. 10. The gNB evaluates if both RIS and gNB support this mode and how many UEs need this specific mode before sending the mode selection request:
      i. The gNB evaluation could be based on UE request via RIS to gNB for a specific mode or gNB need for a specific mode;
2. As shown in step 2 of FIG. 9 there is in accordance with example embodiments of the invention, based on a specific need, the gNB sends a mode selection request to the RIS-MT:
   a. In one example case, the gNB provides the related configuration parameters for RIS to apply the mode. The parameters include the angle of reflection, frequency, phase adjustment, etc.;
3. In accordance with example embodiments of the invention, as shown in step 3a of FIG. 9 the RIS-MT receives a reflection mode request or mode selection request, the feasibility of the requested configuration is checked (as shown in FIG. 11). If the requested configuration is possible, the RIS state will be set to ON state. Operation and maintenance (OAM) controls Beam direction and takes care of beam indexing:
   a. The RIS-MT checks the availability of RIS-Fwd for the reflection mode. As shown in step 3b of FIG. 9 RIS-MT then allocates the passive RIS array elements and reconfigures their parameters (i.e. based on step 2a) for forwarding operation;
4. The RIS sends a mode selection response to the gNB (which could be “yes” in case the RIS is available for this mode, or it could be “no” if RIS is busy with some other tasks, i.e. due to connection with other gNBs e.g. high priority for another mode);
5. Finally, the RIS starts operating in the requested mode. The network enables the UE or gNB access via RIS.

FIG. 10 shows evaluation of the requirement and need for the mode in accordance with example embodiments of the invention. As shown in step 1010 of FIG. 10 there is a Start. As shown in step 1020 of FIG. 10 there is evaluating a capability and/or need for a mode. As shown in step 1030 of FIG. 10 there is determining whether the gNB supports RIS-assisted communication. As shown in step 1040 of FIG. 10 there is determining whether RIS supports this mode. As shown in step 1050 of FIG. 10 there is determining users in a coverage area of RIS. Then as shown in step 1060 of FIG. 10 there is determining an RIS mode selection request. It is noted that if the result of “No” to any of steps 1030, 1040, 1050, or 1060 of FIG. 10, then as shown in step 1070 of FIG. 10 there is an End.

FIG. 11 shows evaluation of the requirement and need for the mode in accordance with example embodiments of the invention. As shown in step 1110 of FIG. 11 there is a Start. As shown in step 1120 of FIG. 10 there is applying a mode selection request. As shown in step 1130 of FIG. 11 there is determining whether a requested configuration is applicable. As shown in step 1140 of FIG. 11, if “yes” to step 1130 of FIG. 11 then as shown in step 1140 of FIG. 11 there is implementing the requested configuration. Then as shown in step 1150 of FIG. 11 there is an RIS for an ON-state. It is noted that if the result of “No” in step 1130 of FIG. 11, then as shown in step 1160 of FIG. 11 there is an End.

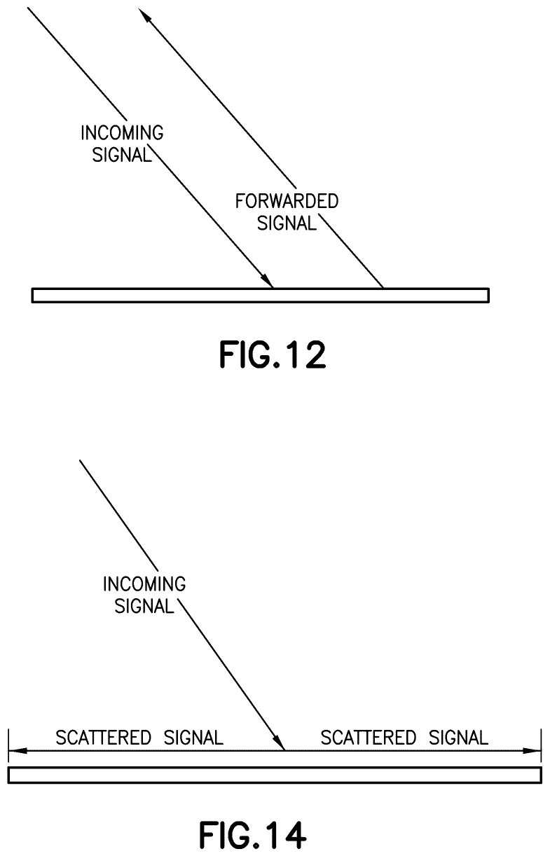

FIG. 12 shows a signal scattering back to the return direction in accordance with example embodiments of the invention. As shown in FIG. 12 there is an incoming signal and a forwarded signal.

### Mirror Mode

Definition: In mirror mode, the beam is scattered back to the return direction of the incident beam as shown in FIG. 12.

Use Cases: Network-initiated mirror mode can be used for channel state evaluation, and estimating the location of RIS or mobile RIS e.g. RIS installed on the rooftop of vehicles.

### Signaling Chart for Mirror Mode

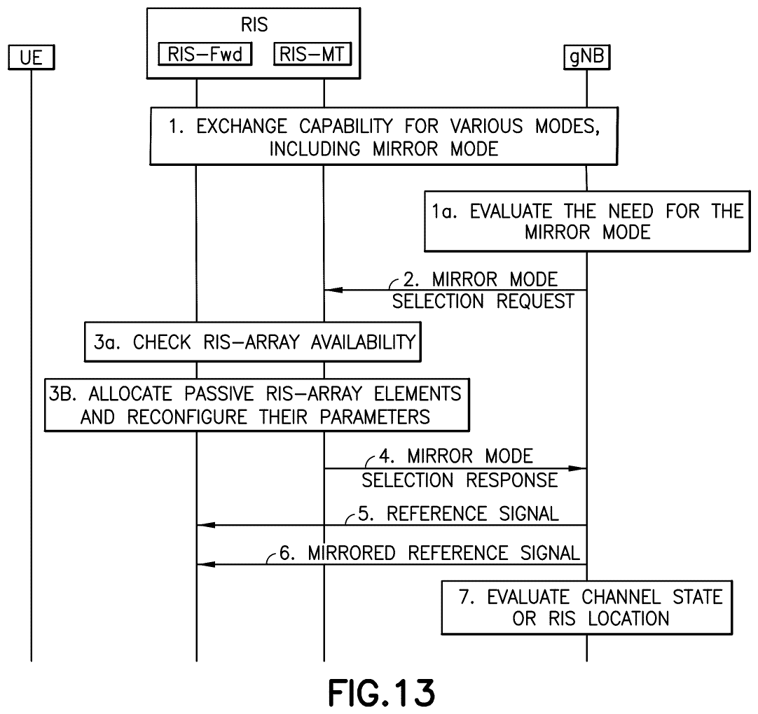

FIG. 13 shows a network-initiated mirror mode selection in accordance with example embodiments of the invention.

The proposed signaling chart is shown in FIG. 13 and described as follows:
1. As shown in step 1 of FIG. 13, in accordance with example embodiments of the invention, the RIS communicates its capability for various modes with one or multiple gNBs. The C-link connection establishment between gNBs and RIS (via RIS-MT) is required before initializing the RIS mirror mode selection:
   a. Based on this capability information, the gNB evaluates the need for mirror mode. As shown in step 1a of FIG. 13, in accordance with example embodiments of the invention, the gNB evaluates if both RIS and gNB support this mode before sending the mode selection request:
      i. The gNB evaluation could be based on the need for channel state evaluation between gNB and RIS, or to estimate the location of RIS or mobile RIS e.g. RIS installed on the rooftop of vehicles;
2. As shown in step 2 of FIG. 13, in accordance with example embodiments of the invention, based on a specific need, the gNB sends a mirror mode selection request to the RIS:
   a. In one example case, the gNB provides the related configuration parameters for RIS to apply the mode. The parameters include the angle of reflection, frequency, phase adjustment, etc.;
3. As shown in step 3a of FIG. 13, in accordance with example embodiments of the invention, the RIS-MT checks the availability of RIS-Fwd for the mirror mode. As shown in step 3b of FIG. 13, in accordance with example embodiments of the invention, the RIS-MT then allocates the passive RIS array elements and reconfigures their parameters (i.e. based on step 2a) for forwarding operation. If the requested configuration is possible, the RIS state will be set to ON state;
4. As shown in step 4 of FIG. 13, in accordance with example embodiments of the invention, the RIS-MT sends a mirror mode selection response to one or multiple gNBs (which could be “yes” in case the RIS is available for this mode, or it could be “no” if RIS is busy with some other tasks, i.e. due to connection with other gNBs e.g. high priority for another mode);
5. As shown in step 5 of FIG. 13, in accordance with example embodiments of the invention, the gNBs send reference signals for channel state estimation between gNBs and RIS or to locate the mobile RIS;
6. As shown in step 6 of FIG. 13, in accordance with example embodiments of the invention, the RIS mirrors the incoming reference signals towards the gNBs;
7. As shown in step 7 of FIG. 13, in accordance with example embodiments of the invention, the network estimates the channel state or RIS location using the received mirrored signal.

### OFF Mode

Definition: OFF state means no forwarding operation. OFF state can be implemented in several ways e.g. using the absorptive mode, uniform scattering mode, and surface wave mode. Using the scattering (if supported), RIS scatters the beam into multiple beams over a wide angle. Due to scattering, the signal will begin to lose its integrity and will eventually die out. Using the Absorption mode, the RIS nulls the incident beams as shown in FIG. 14. Absorption mode can be implemented in several ways such as:
Using absorption in which the radiant power is transformed to another type of energy, usually heat;
Using surface waves in which the incoming waveform is converted to propagate on the antenna surface as a surface wave.

FIG. 14 shows absorption of the signal in accordance with example embodiments of the invention. As shown in FIG. 14 there is an incoming signal an scattering of the signal in all directions.

Use Cases: OFF mode can be requested e.g., for avoiding interferences. The OFF mode can also be essential when network changes are to be implemented.

### Signaling Chart for OFF Mode

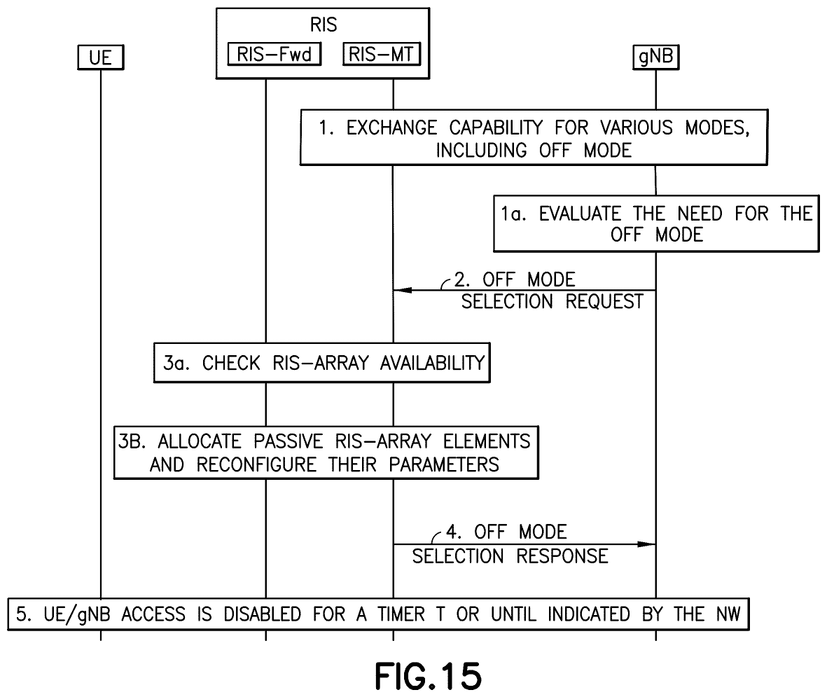

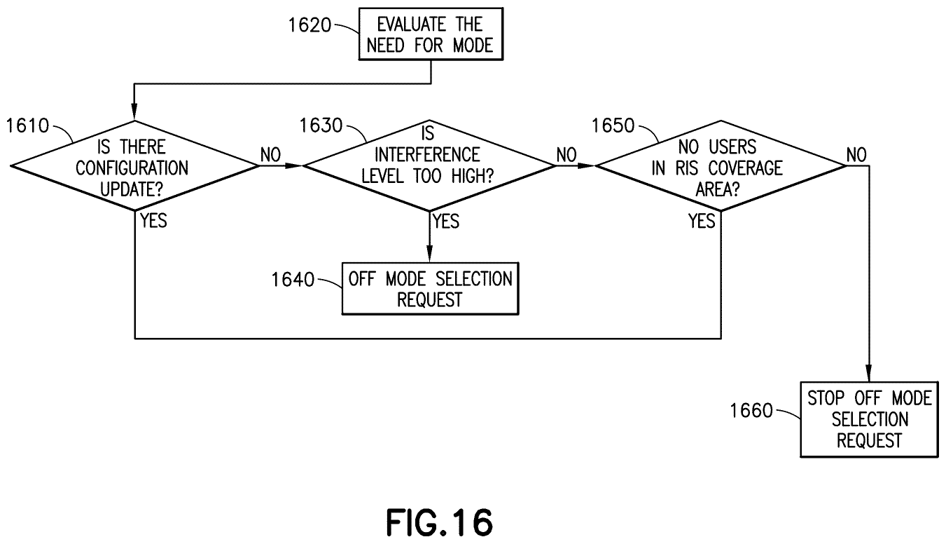

A proposed signaling chart in accordance with example embodiments of the invention is shown in FIG. 15 and described as follows:
1. As shown in step 1 of FIG. 15, in accordance with example embodiments of the invention, the RIS communicates its capability for various modes with gNBs. The C-link connection establishment between gNBs and RIS (via RIS-MT) is required before initializing the RIS OFF mode selection:
   a. Based on this capability information, ss shown in step 1a of FIG. 15, in accordance with example embodiments of the invention, the gNB evaluates the need for OFF mode. The gNB evaluates if both RIS and gNB support this mode before sending the mode selection request:
      i. The gNB evaluation could be based on the triggering conditions e.g., configuration update, high interference level, or lack of users as shown in FIG. 16;
2. As shown in step 2 of FIG. 15, in accordance with example embodiments of the invention, based on a specific need, the gNB sends an OFF-mode selection request to the RIS-MT:
   a. In one example case, the gNB provides the related configuration parameters for RIS to apply the mode. The parameters include the angle of reflection, frequency, phase adjustment, etc.;
3. As shown in step 3a of FIG. 15, in accordance with example embodiments of the invention, the RIS-MT checks the availability of RIS-Fwd for the OFF mode. The RIS-MT then allocates the passive RIS array elements and reconfigures their parameters (i.e. based on step 2a) for OFF operation;
4. As shown in step 4 of FIG. 15, in accordance with example embodiments of the invention, the RIS-MT sends an OFF-mode selection response to gNB (which could be “yes” in case the RIS is available for this mode, or it could be “no” if RIS is busy with some other tasks, i.e. due to connection with other gNBs e.g. high priority for another mode);
5. As shown in step 5 of FIG. 15, in accordance with example embodiments of the invention, the RIS applies the OFF-mode configuration. The UE or gNB access via RIS is disabled for a timer T or until indicated by the network.

FIG. 16 shows evaluation of a need for RIS OFF state in accordance with example embodiments of the invention. As shown in step 1610 of FIG. 16 there is determining whether a configuration is updated. If “Yes” to step 1610 of FIG. 16 then as shown in step 1620 of FIG. 16 of evaluating the need for a mode. If “No” at step 1610 of FIG. 16 then as shown in step 1630 of FIG. 16 there is determining if interference level is too high. If it is determined at step 1630 the interference level is too high, then as shown in step 1640 of FIG. 16 an OFF mode selection request. If it is determined at step 1630 the interference level is not too high, then as shown in step 1650 of FIG. 16 there is determining users in a coverage area. If “Yes” at step 1650 then the operations return to step 1610. If “No” at step 1650 then as shown in step 1660 of FIG. 16 there is a stop off mode selection request.

### Cascade Mode

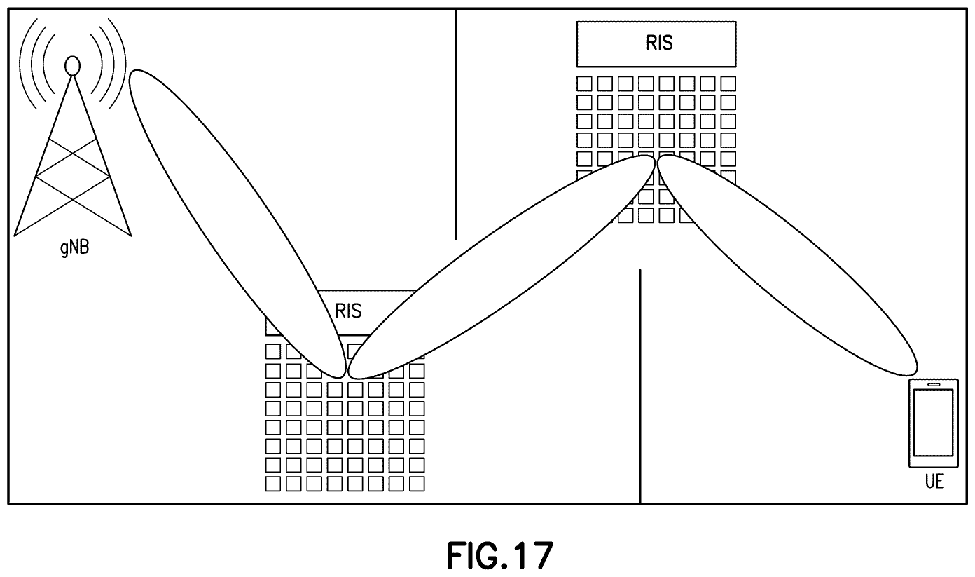

FIG. 17 shows a linked RISs create a virtual LOS and connection between UE and gNB in accordance with example embodiments of the invention. As shown in FIG. 17, there is communication between a gNB and UE via two RIS.

Definition: In cascading mode, several RISs are linked together as shown in FIG. 17. Several linked RISs help UE to form a connection with BSs regardless of blockages in the environment. The Cascade mode utilizes a distributed multi-RIS network. RISs which are densely deployed across the propagation environment can enhance the communication's QoS by serving virtual LOS connection in NLOS conditions with high penetration losses.

Use Cases: Due to the high penetration loss, such a link is not feasible without the assistance of multiple RISs. In addition, to avoid blockages in a complicated environment, multiple RIS can be configured in a cascaded manner for coverage extension. The network can initiate cascade mode when it is aware of the availability of distributed multiple RISs.

### Signaling Chart for Cascaded Mode

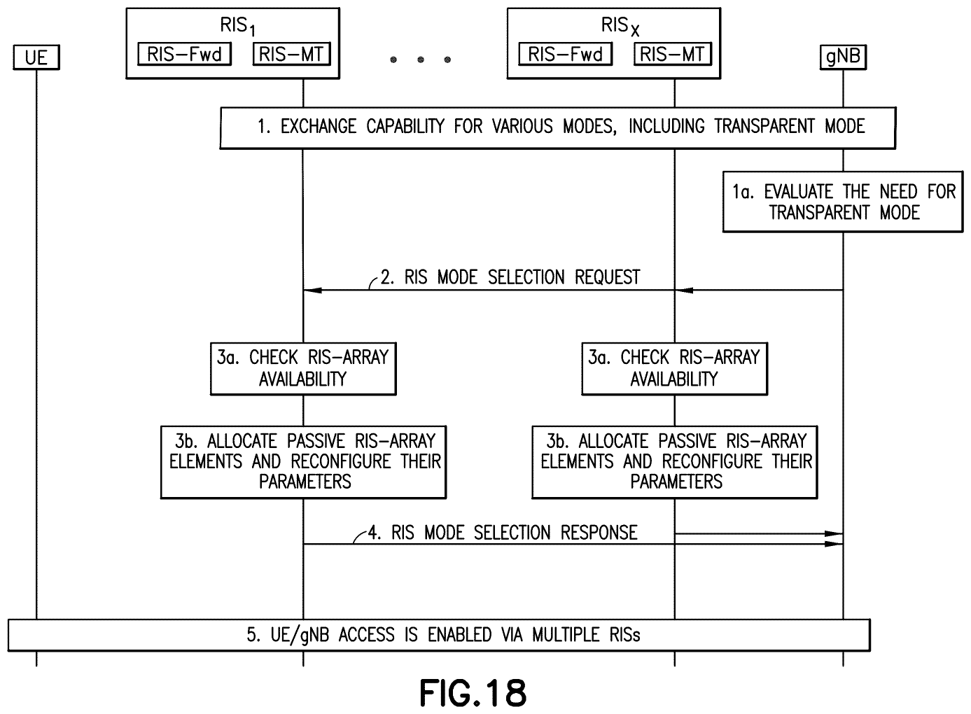

A proposed signaling chart in accordance with example embodiments of the invention is shown in FIG. 18 and described as follows:
1. As shown in step 1 of FIG. 18, in accordance with example embodiments of the invention, the RIS communicates its capability for various modes with gNBs. The C-link connection establishment between gNBs and RIS (via RIS-MT) is required before initializing the RIS cascaded mode selection:
   a. Based on this capability information, the gNB evaluates the need for cascaded mode. As shown in step 1a of FIG. 18, in accordance with example embodiments of the invention, the gNB evaluates if all RISs and gNB support this mode before sending the mode selection request:
      i. The gNB evaluation could be based on the evaluation of the weak link of a UE using a single RIS, ii. All distributed RISs (from RIS1 to RISx) are on ON-state;
2. As shown in step 2 of FIG. 18, in accordance with example embodiments of the invention, the gNB sends a cascaded mode selection request to more than one RIS-MTs:
   a. In one example case, the gNB provides the related configuration parameters for RIS to apply the mode. The parameters include the angle of reflection, frequency, phase adjustment, etc.;
3. As shown in step 3a of FIG. 18, in accordance with example embodiments of the invention, the RIS-MTs check the availability of RIS-Fwds for the cascaded mode. As shown in step 3b of FIG. 18, in accordance with example embodiments of the invention, the RIS-MT then allocates the passive RIS array elements and reconfigures their parameters (i.e. based on step 2a) for forwarding operation. If the requested configuration is possible, the RIS state will be set to ON state;
4. As shown in step 4 of FIG. 18, in accordance with example embodiments of the invention, the all RISs send a cascaded mode selection response to gNB (which could be “yes” in case the RIS is available for this mode, or it could be “no” if RIS is busy with some other tasks, i.e. due to connection with other gNBs e.g. high priority for another mode);
5. If the RIS is available for the requested mode, then based on the received parameters, the RIS applies the cascaded mode configuration;
6. As shown in step 5 of FIG. 18, in accordance with example embodiments of the invention, the UE or gNB access via multiple RIS is enabled.

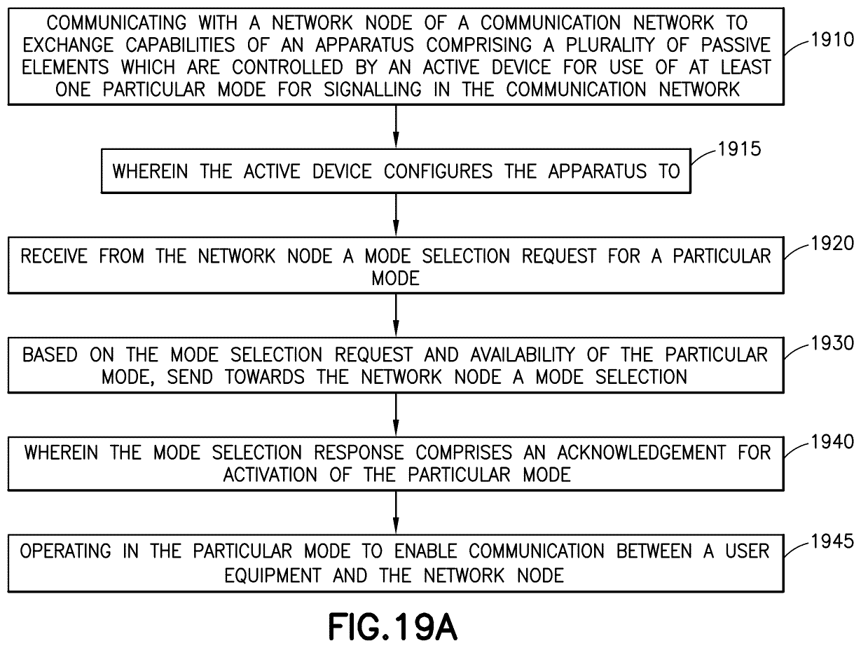

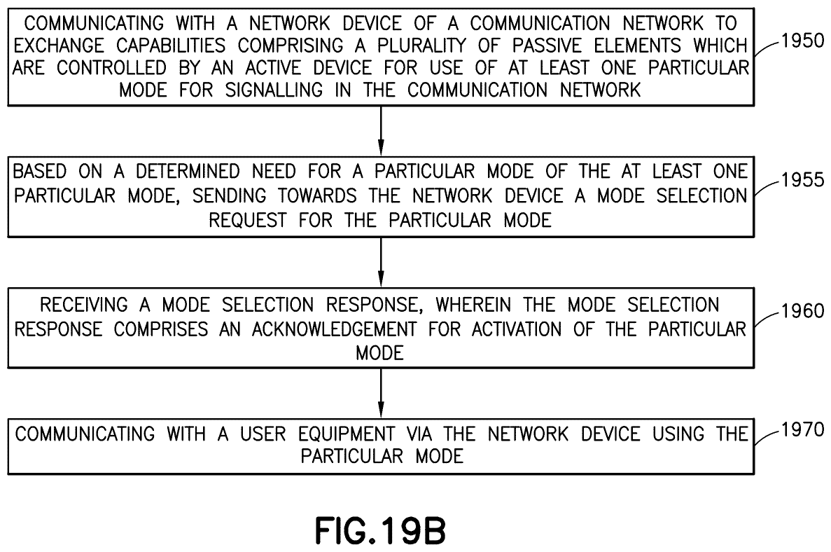

FIG. 19A and FIG. 19B each show a method in accordance with example embodiments of the invention which may be performed by an apparatus

FIG. 19A illustrates operations which may be performed by a device such as, but not limited to, a device such as a network node (e.g., the gNB 170 as in FIG. 5). As shown in block 1910 of FIG. 19A there is communicating with a network node of a communication network to exchange capabilities of the apparatus comprising a plurality of passive elements which are controlled by an active device for use of at least one particular mode for signalling in the communication network. As shown in block 1915 wherein the active device configures the apparatus to: As shown in block 1920 of FIG. 19A there is, receiving from the network node a mode selection request for a particular mode. As shown in block 1930 of FIG. 19A there is, based on the mode selection request and availability of the particular mode, send towards the network node a mode selection response. As shown in block 1940 of FIG. 19A there is wherein the mode selection response comprises an acknowledgement for activation of the particular mode. Then as shown in block 1945 of FIG. 19A there is operating in the particular mode to enable communication between a user equipment and the network node.

In accordance with the example embodiments as described in the paragraph above, wherein the mode selection response indicates whether the apparatus is available for the particular mode.

In accordance with the example embodiments as described in the paragraphs above, wherein the apparatus comprises at least one of a reconfigurable intelligent surface (RIS), intelligence reflecting surfaces (IRS), large intelligent surfaces, or array of reconfigurable reflecting antenna elements.

In accordance with the example embodiments as described in the paragraphs above, wherein the apparatus comprises a reconfigurable intelligent surface comprising a reconfigurable intelligent surface control unit and a reconfigurable intelligent surface forwarding unit.

In accordance with the example embodiments as described in the paragraphs above, wherein there is checking availability with the reconfigurable intelligent surface forwarding unit for the particular mode of operation; and allocating passive array elements and reconfigure using the parameters for a forwarding operation.

In accordance with the example embodiments as described in the paragraphs above, wherein the identifying the apparatus is available is based on a mode selection response.

In accordance with the example embodiments as described in the paragraphs above, wherein the at least one particular mode comprises a reflection mode, transparent mode, a half-duplex or full-duplex mode, a mirror mode, an off mode, and a cascade mode.

In accordance with the example embodiments as described in the paragraphs above, wherein in the reflection mode the apparatus reflects the signalling towards a desired direction based on a configuration.

In accordance with the example embodiments as described in the paragraphs above, wherein beams of the reflection mode for the signalling are symmetrical in an uplink and a downlink direction, and wherein a ratio between an incident angle and a reflected angle are equal.

In accordance with the example embodiments as described in the paragraphs above, wherein the reflection mode is one option for a forwarding operation based on the particular mode being available.

In accordance with the example embodiments as described in the paragraphs above, wherein in the transparent mode the apparatus applies a transparent mode operation to refract a beam for transmitting the signalling towards a specified direction.

In accordance with the example embodiments as described in the paragraphs above, wherein the refraction mode is one option for forwarding based on the particular mode being available.

In accordance with the example embodiments as described in the paragraphs above, wherein in the half duplex mode, the signalling is transmitted with time Division duplexing or frequency-division duplexing, wherein the half duplex mode is a default mode.

In accordance with the example embodiments as described in the paragraphs above, wherein the apparatus enables spatial multiplexing for a full-duplex mode, wherein based on spatial multiplexing being used for forwarding the signalling, the full-duplex mode is enabled with simultaneous uplink transmission and downlink transmission, and wherein elements of the apparatus are functionally divided into a part that forwards the uplink transmission and another part that forwards the downlink transmission.

In accordance with the example embodiments as described in the paragraphs above, wherein in full-duplex mode, the signalling is transmitted in uplink and downlink directions on a same frequency range at a same time.

In accordance with the example embodiments as described in the paragraphs above, wherein in the mirror mode, a beam is scattered back to the return direction of an incident beam.

In accordance with the example embodiments as described in the paragraphs above, wherein the mirror mode is used for channel state evaluation, and estimating the location of the apparatus or a mobile terminal.

In accordance with the example embodiments as described in the paragraphs above, wherein in the off mode, there is no forwarding operation, wherein the off mode is implemented by at least one of using the absorptive mode, uniform scattering mode, and surface wave mode, or using scattering, and wherein a scattering functionality scatters a beam into multiple beams over a wide angle, wherein absorption transforms the radiant power to another type of energy, and wherein surface waves convert incoming waveforms to propagate on the antenna surface as a surface wave.

In accordance with the example embodiments as described in the paragraphs above, wherein in the cascade mode at least one reconfigurable intelligent surface of the apparatus is linked to help form a connection overcoming blockages.

In accordance with the example embodiments as described in the paragraphs above, wherein parameters of the configuration comprise an angle of reflection, frequency, and a phase adjustment.

In accordance with the example embodiments as described in the paragraphs above, wherein the determined need for the particular mode is based on whether there are other network devices in a coverage area of the apparatus.

In accordance with the example embodiments as described in the paragraphs above, wherein enabling forwarding using the particular mode is based on implementing the configuration using parameters and applying an on state.

A non-transitory computer-readable medium (Memory(ies) 155 as in FIG. 5) storing program code (computer program code 153 and/or output module 150-2 as in FIG. 5), the program code executed by at least one processor (Processor(s) 152 and/or output module 150-1 as in FIG. 5) to perform the operations as at least described in the paragraphs above.

In accordance with an example embodiment of the invention as described above there is an apparatus comprising: means for communicating (one or more transceivers 160, Memory(ies) 155, computer program code 153 and/or output module 150-2, and at least one processor (Processor(s) 152 and/or output module 150-1 as in FIG. 5) with a network node of a communication network to exchange (one or more transceivers 160, Memory(ies) 155, computer program code 153 and/or output module 150-2, and at least one processor (Processor(s) 152 and/or output module 150-1 as in FIG. 5) capabilities of the apparatus comprising a plurality of passive elements which are controlled by an active device for use of at least one particular mode for signalling in the communication network, wherein the active device configures (one or more transceivers 160, Memory(ies) 155, computer program code 153 and/or output module 150-2, and at least one processor (Processor(s) 152 and/or output module 150-1 as in FIG. 5) the apparatus to perform: means for receiving (one or more transceivers 130, Memory(ies) 125, computer program code 123 and/or output module 140-2, and at least one processor (Processor(s) 120 and/or output module 140-1 as in FIG. 5) from the network node a mode selection request for a particular mode; means, based on the mode selection request and availability of the particular mode, for sending (one or more transceivers 160, Memory(ies) 155, computer program code 153 and/or output module 150-2, and at least one processor (Processor(s) 152 and/or output module 150-1 as in FIG. 5) towards the network node a mode selection response, wherein the mode selection response comprises an acknowledgement for activation of the particular mode; and means for operating (one or more transceivers 160, Memory(ies) 155, computer program code 153 and/or output module 150-2, and at least one processor (Processor(s) 152 and/or output module 150-1 as in FIG. 5) in the particular mode to enable communication between a user equipment and the network node.

In the example aspect of the invention according to the paragraph above, wherein at least the means for communicating, exchanging, configuring, receiving, sending, and operating comprises Memory(ies) 155 embodied on computer program code 153 and/or output module 150-2, and executed by at least one processor and/or module (Processor(s) 152 and/or output module 150-1) as in FIG. 5.

FIG. 19B illustrates operations which may be performed by a device such as, but not limited to, a device such as a network device (e.g., the UE 110 as in FIG. 5). As shown in block 1950 of FIG. 19B there is communicating with a network device of a communication network to exchange capabilities comprising a plurality of passive elements which are controlled by an active device for use of at least one particular mode for signalling in the communication network. As shown in block 1955 of FIG. 19B there is, based on a determined need for a particular mode of the at least one particular mode, sending towards the network device a mode selection request for the particular mode. As shown in block 1960 of FIG. 19B there is, receiving a mode selection response, wherein the mode selection response comprises an acknowledgement for activation of the particular mode. As shown in block 1970 of FIG. 19B there is, communicating with a user equipment via the network device using the particular mode.

In accordance with the example embodiments as described in the paragraph above, wherein the mode selection response indicates whether the apparatus is available for the particular mode.

In accordance with the example embodiments as described in the paragraphs above, wherein the apparatus comprises at least one of a reconfigurable intelligent surface (RIS), intelligence reflecting surfaces (IRS), large intelligent surfaces, or array of reconfigurable reflecting antenna elements.

In accordance with the example embodiments as described in the paragraphs above, wherein the apparatus comprises a reconfigurable intelligent surface comprising a reconfigurable intelligent surface control unit and a reconfigurable intelligent surface forwarding unit.

In accordance with the example embodiments as described in the paragraphs above, wherein the mode selection response is based on a checking of availability for the particular mode of operation; and allocation of passive array elements and reconfigure using the parameters for a forwarding operation.

In accordance with the example embodiments as described in the paragraphs above, wherein identifying the apparatus is available is based on a mode selection response.

In accordance with the example embodiments as described in the paragraphs above, wherein there is identifying at least one reconfigurable intelligent surface is available for a particular mode based on a mode selection response from one or more reconfigurable intelligent surface.

In accordance with the example embodiments as described in the paragraphs above, wherein the at least one particular mode comprises a reflection mode, transparent mode, a half-duplex or full-duplex mode, a mirror mode, an off mode, and a cascade mode.

In accordance with the example embodiments as described in the paragraphs above, wherein in the reflection mode the apparatus reflects the signalling towards a desired direction based on a configuration.

In accordance with the example embodiments as described in the paragraphs above, wherein beams of the reflection mode for the signalling are symmetrical in an uplink and a downlink direction, and wherein a ratio between an incident angle and a reflected angle are equal.

In accordance with the example embodiments as described in the paragraphs above, wherein the reflection mode is one option for a forwarding operation based on the particular mode being available.

In accordance with the example embodiments as described in the paragraphs above, wherein in the transparent mode the apparatus applies a transparent mode operation to refract a beam for transmitting the signalling towards a specified direction.

In accordance with the example embodiments as described in the paragraphs above, wherein the refraction mode is one option for forwarding based on the particular mode being available.

In accordance with the example embodiments as described in the paragraphs above, wherein in the half duplex mode, the signalling is transmitted with time Division duplexing or frequency-division duplexing, wherein the half duplex mode is a default mode.

In accordance with the example embodiments as described in the paragraphs above, wherein the apparatus enables spatial multiplexing for a Frequency-division mode, wherein based on spatial multiplexing being used for forwarding the signalling, the frequency-division mode is enabled with simultaneous uplink transmission and downlink transmission, and wherein elements of the apparatus are functionally divided into a part that reflects the uplink transmission and another part that reflects the downlink transmission.

In accordance with the example embodiments as described in the paragraphs above, wherein in full-duplex mode, the signalling is transmitted in uplink and downlink directions on a same frequency range at a same time.

In accordance with the example embodiments as described in the paragraphs above, wherein in the mirror mode, a beam is scattered back to the return direction of an incident beam.

In accordance with the example embodiments as described in the paragraphs above, wherein the mirror mode is used for channel state evaluation, and estimating the location of a mobile at least one reconfigurable intelligent surface for communicating.

In accordance with the example embodiments as described in the paragraphs above, wherein in the off mode, there is no forwarding operation, wherein the off mode is implemented by at least one of using the absorptive mode, uniform scattering mode, and surface wave mode, or using scattering, and wherein a beam is scattered into multiple beams over a wide angle.

In accordance with the example embodiments as described in the paragraphs above, wherein in the cascade mode at least one user equipment is linked to help form a connection overcoming blockages.

In accordance with the example embodiments as described in the paragraphs above, wherein the parameters comprise an angle of reflection, frequency, and a phase adjustment.

In accordance with the example embodiments as described in the paragraphs above, wherein the determined need for the particular mode is based on whether there are other network devices in a coverage area of the reconfigurable intelligent surface.

In accordance with the example embodiments as described in the paragraphs above, wherein enabling forwarding using the particular mode is based on implementing the configuration using parameters and applying an on state to the reconfigurable intelligent surface.

A non-transitory computer-readable medium (Memory(ies) 125 as in FIG. 5) storing program code (computer program code 123 and/or output module 140-2 as in FIG. 5), the program code executed by at least one processor (Processor(s) 120 and/or output module 140-1 as in FIG. 5) to perform the operations as at least described in the paragraphs above.

In accordance with an example embodiment of the invention as described above there is an apparatus comprising: means for communicating (one or more transceivers 130, Memory(ies) 125, computer program code 123 and/or output module 140-2, and at least one processor (Processor(s) 120 and/or output module 140-1 as in FIG. 5) with a network device of a communication network to exchange capabilities comprising a plurality of passive elements which are controlled (one or more transceivers 130, Memory(ies) 125, computer program code 123 and/or output module 140-2, and at least one processor (Processor(s) 120 and/or output module 140-1 as in FIG. 5) by an active device for use of at least one particular mode for signalling in the communication network; means, based on a determined need for a particular mode of the at least one particular mode, for sending (one or more transceivers 130, Memory(ies) 125, computer program code 123 and/or output module 140-2, and at least one processor (Processor(s) 120 and/or output module 140-1 as in FIG. 5) towards the network device a mode selection request for the particular mode; means for receiving (one or more transceivers 130, Memory(ies) 125, computer program code 123 and/or output module 140-2, and at least one processor (Processor(s) 120 and/or output module 140-1 as in FIG. 5) the mode selection response, wherein the mode selection response comprises an acknowledgement for activation of the particular mode; and means for communicating (one or more transceivers 130, Memory(ies) 125, computer program code 123 and/or output module 140-2, and at least one processor (Processor(s) 120 and/or output module 140-1 as in FIG. 5) with the network device via the network device using the particular mode.

In the example aspect of the invention according to the paragraph above, wherein at least the means for communicating, controlling, sending, receiving, and communicating comprises Memory(ies) 125 embodied on computer program code 123 and/or output module 140-2, and executed by at least one processor and/or module (Processor(s) 120 and/or output module 140-1) as in FIG. 5.

It is noted that advantages of proposed solutions in accordance with example embodiments of the invention include at least:
Enabling various RIS mode (re) selection;
Operating RIS with different modes;
Allowing RIS to go to an OFF state;
Allowing RIS to operate in a cascaded manner; and
Low-cost/Low-energy solution

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable):
(i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1.-20. (canceled)

21. An apparatus, comprising:
at least one processor; and
at least one memory storing instructions, that when executed by the at least one processor, cause the apparatus at least to:
communicate with a network node of a communication network to exchange capabilities of the apparatus comprising a plurality of passive elements which are controlled by an active device for use of at least one particular mode for signalling in the communication network, wherein the active device configures the apparatus to:
receive from the network node a mode selection request for a particular mode;
based on the mode selection request and availability of the particular mode, send towards the network node a mode selection response,
wherein the mode selection response comprises an acknowledgement for activation of the particular mode; and
operating in the particular mode to enable communication between a user equipment and the network node.

22. The apparatus of claim 21, wherein the mode selection response indicates whether the apparatus is available for the particular mode.

23. The apparatus of claim 21, wherein the apparatus comprises at least one of a reconfigurable intelligent surface (RIS), intelligence reflecting surfaces (IRS), large intelligent surfaces, or array of reconfigurable reflecting antenna elements.

24. The apparatus of claim 21, wherein the apparatus comprises a reconfigurable intelligent surface that comprises a reconfigurable intelligent surface control unit and a reconfigurable intelligent surface forwarding unit.

25. The apparatus of claim 24, wherein the at least one memory is storing instructions executed by the at least one processor, to further cause the apparatus at least to:
check availability with the reconfigurable intelligent surface forwarding unit for the particular mode of operation; and
allocate passive array elements and
reconfigure using the parameters for a forwarding operation.

26. The apparatus of claim 21, wherein the at least one particular mode comprises a reflection mode, transparent mode, a half-duplex or full-duplex mode, a mirror mode, an off mode, and a cascade mode.

27. The apparatus of claim 26, wherein in the reflection mode the apparatus reflects the signalling towards a desired direction based on a configuration.

28. The apparatus of claim 27, wherein beams of the reflection mode for the signalling are symmetrical in an uplink and a downlink direction, and wherein a ratio between an incident angle and a reflected angle are equal.

29. The apparatus of claim 26, wherein in the transparent mode the apparatus applies a transparent mode operation to refract a beam for transmitting the signalling towards a specified direction.

30. The apparatus of claim 26, wherein in the half duplex mode, the signalling is transmitted with time division duplexing or frequency-division duplexing, wherein the half duplex mode is a default mode.

31. The apparatus of claim 26, wherein the apparatus enables spatial multiplexing for a full-duplex mode,
wherein based on spatial multiplexing being used for forwarding the signalling, the full-duplex mode is enabled with simultaneous uplink transmission and downlink transmission, and wherein elements of the apparatus are functionally divided into a part that forwards the uplink transmission and another part that forwards the downlink transmission.

32. The apparatus of claim 21, wherein in the full-duplex mode, the signalling is transmitted in uplink and downlink directions on a same frequency range at a same time.

33. The apparatus of claim 26, wherein in the mirror mode, a beam is scattered back to the return direction of an incident beam.

34. The apparatus of claim 33, wherein the mirror mode is used for channel state evaluation, and estimating the location of at least one of reconfigurable intelligent surface or a mobile terminal.

35. The apparatus of claim 26, wherein in the off mode, there is no forwarding operation,
wherein the off mode is implemented by at least one of using the absorptive mode, uniform scattering mode, and surface wave mode, or using scattering, and
wherein scattering functionality of a beam is scattered into multiple beams over a wide angle,
wherein absorption of at least one reconfigurable intelligent surface transforms the radiant power to another type of energy, and
wherein surface waves convert incoming waveforms to propagate on the antenna surface as a surface wave.

36. The apparatus of claim 26, wherein in the cascade mode at least one reconfigurable intelligent surface is linked to help form a connection overcoming blockages.

37. The apparatus of claim 21, wherein the at least one memory is storing instructions executed by the at least one processor, to further cause the apparatus at least to:
enable forwarding in the particular mode based on implementing the configuration using parameters and applying an on state to the apparatus.

38. A method, comprising:
communicating with a network node of a communication network to exchange capabilities of an apparatus comprising a plurality of passive elements which are controlled by an active device for use of at least one particular mode for signalling in the communication network, wherein the active device configures the reconfigurable intelligent surface to perform:
receiving from the network node a mode selection request for a particular mode;
based on the mode selection request and availability of the particular mode, sending towards the network node a mode selection response,
wherein the mode selection response comprises an acknowledgement for activation of the particular mode; and
operating in the particular mode to enable communication between a user equipment and the network node.

39. An apparatus, comprising:
at least one processor; and
at least one memory storing instructions, that when executed by the at least one processor, cause the apparatus at least to:
communicate with a network device of a communication network to exchange capabilities comprising a plurality of passive elements which are controlled by an active device for use of at least one particular mode for signalling in the communication network;
based on a determined need for a particular mode of the at least one particular mode, send towards the network device a request for the particular mode;
receive a mode selection response, wherein the mode selection response comprises an acknowledgement for activation of the particular mode; and
communicate with a user equipment via the network device using the particular mode.

40. The apparatus of claim 19, wherein the at least one memory is storing instructions executed by the at least one processor to cause the apparatus at least to:
identify at least one reconfigurable intelligent surface is available for a particular mode based on a mode selection response from one or more reconfigurable intelligent surface.
